(19) United States
(12) Patent Application Publication
(10) Pub. No.: US 2022/0296030 A1
(43) Pub. Date: Sep. 22, 2022

(54) RETROFIT INFUSER

(71) Applicant: P.S. KREATIVE, LLC, Grand Junction, CO (US)

(72) Inventors: Michael Schultz, Grand Junction, CO (US); Aaron Clymer, Grand Junction, CO (US)

(73) Assignee: P.S. Kreative, LLC, Grand Junction, CO (US)

(21) Appl. No.: 17/698,462

(22) Filed: Mar. 18, 2022

Related U.S. Application Data
(60) Provisional application No. 63/163,632, filed on Mar. 19, 2021.

(51) Int. Cl. A47J 31/06; A47J 31/20

(52) U.S. Cl. CPC A47J 31/0636; A47J 31/20

(57) ABSTRACT

A retrofit infuser may be configured to be used with a drinking container to allow material, held within the infuser, to be infused within a liquid of the drinking container. The material may be fruits, vegetables, teas, coffee beans, coffee grounds, or other food and drink related items. The infuser may include a lid. The lid may be configured to removably secure the infuser within a neck of the drinking container or to float atop a liquid in the drinking container. The infuser may include a cage configured to hold the material to be infused and to allow the material to be infused into the liquid of the drinking container. The cage may be configured to be removably secured within the lid of the infuser. The infuser may further be configured to removably secure to a straw of the drinking container.

### RELATED APPLICATIONS

This application claims priority to U.S. Provisional Application Ser. No. 63/163,632, filed Mar. 19^{th} 2021.

### BACKGROUND OF THE INVENTION

Many people in the United States and across the world use water bottles or other liquid holding containers to carry water or some other drinkable liquid with them to work, on recreational activities, running errands, and even just to use in the home. It is well known that drinking enough water and other liquids to stay hydrated offers many important health benefits.

There are many different varieties of water bottles and other liquid holding containers known in the art that are used by people across the world on a daily basis. Therefore, it would be advantageous and welcomed to provide accessories that work in conjunction with these known liquid holding containers to provide users with more functionality and different user experiences with their liquid holding containers.

Accordingly, there has been an ongoing need for improvements in and new offerings for accessories that work in conjunction with known water bottles and liquid carrying containers. Therefore, new designs and functional features for accessories that work in conjunction with or apart of water bottles and liquid carrying containers would be well received by the general public.

### SUMMARY OF THE INVENTION

Various embodiments of an infuser may include a lid being generally disc-like in shape and a cage configured to hold various material to be infused within a liquid held within the drinking container. The infuser may be configured to be inserted within the drinking container. Additionally, or alternatively, the infuser may be configured to be removably secured within a neck of the drinking container. Additionally, or alternatively, the infuser may be configured to removably secure to a drinking straw of the drinking container or to receive the drinking straw such that the drinking straw is removably securable to the infuser.

In one embodiment, the lid may include a top, a bottom, an outer lateral surface, and a flap extending outward from the outer lateral surface of the lid. When the lid is placed within the neck of a drinking container, the flap may push against an inner wall of the neck, helping to secure the lid within the neck of the drinking container. The cage may be a hollow body with a chamber on the inside defined by the hollow body. The hollow body may have a plurality of apertures extending through the hollow body. The hollow body may also have a rim which defines an opening to the chamber of the cage. The rim of the cage may be secured within the bottom of the lid.

The lid may extend completely around and outward from a circumference of the outer lateral surface. The flap may also include a notch such that the notch forms a spout when the lid is inserted into the neck of the drinking container. The notch may not quite extend to the outer lateral surface of the lid. Alternatively, the notch may extend all the way to the outer lateral surface of the lid. The flap may also include a second notch. The second notch may similarly not quite extend to the outer lateral surface of the lid or extend to the outer lateral surface of the lid. The second notch may be positioned such that it is on the opposite side of the flap from the first notch. The second notch may also be smaller than the first notch in size.

The lid may further include a second flap, the second flap may be identical to the first flap as described above. However, the second flap may be positioned lower than the first flap such that a channel is formed around the circumference of the outer lateral surface of the lid.

The lid may further include a mound extending out of the bottom of the lid. When the rim of the cage is removably secured to the bottom of the lid, the mound may partially extend into the chamber. The lid may further include a second mound also extending out of the bottom of the lid. The second mound may also extend partially into the chamber when the rim of the cage is removably secured to the bottom of the lid. The mounds may act to push against the inside of the cage when the rim of the cage is removably secured to the bottom of the lid so as to help secure the cage to the lid.

The lid may also include a handle that may be grasped by a user to assist the user in placing the infuser within the drinking container and also in removing the infuser from the drinking container.

In another embodiment, the cage may be configured to removably secure to a drinking straw of a drinking container. For example, some drinking containers have lids with a foldout spout on the top to drink from and a drinking straw connected to the bottom of the lid and extending into the drinking container. Others have straws within the drinking container and extending out of the lid. For drinking containers with straws, the cage may be configured to secure to the drinking straw. The cage may include a clip exposed on the exterior of the cage in which the straw may be removably secured. In this manner, the infuser may be suspended within the drinking container from the straw.

The cage may include a channel along its length that may be configured to receive a straw. The clip may be positioned within the channel. In this embodiment, the straw may be inserted into the channel and removable secured with the clip positioned within the channel.

The cage may include a rim configured to fit within a bottom of the lid of the drinking container. The rim may have a notch located at one end of the channel. The cage may have a wall parallel to the rim and positioned between the notch and the channel. The wall may be positioned orthogonally to the channel. An aperture may extend through the wall such that the straw may be inserted through the aperture and into the channel. In some embodiments, the clip may be included within the channel at the opposite end of the channel as the wall.

In another embodiment, the infuser may be comprised of a cage as described above and a lid that is generally disc-like in shape. The lid may have a top, a bottom rim, an outer lateral surface having a length between the bottom rim and the top, and aa handle being configured to be grasped by a user. The cage may be removably secured within the bottom of the lid. The infuser may also have an air pocket that give the infuser enough buoyancy to float above the bottom of the drinking container. The air pocket may be disposed within the lid. Alternatively, the air pocket may be disposed within the cage.

Other features and advantages of the various embodiments of the infuser will become apparent from the following more detailed description, taken in conjunction with the accompanying drawings, which illustrate, by way of example, the principles of the various embodiments of the infuser.

### BRIEF DESCRIPTION OF THE DRAWINGS

Various embodiments will be described and explained with additional specificity and detail through the use of the accompanying drawings in which:

FIG. 1 illustrates a top perspective view of a retrofit infuser;

FIG. 2 illustrates a bottom perspective view of the infuser of FIG. 1;

FIG. 3 illustrates an exploded perspective view of the infuser of FIGS. 1-2;

FIG. 4 illustrates a bottom plan view of the infuser of FIGS. 1-3;

FIG. 5 illustrates a top perspective view of a lid of the infuser of FIGS. 1-4;

FIG. 6 illustrates a bottom perspective view of the lid of FIG. 5;

FIG. 7 illustrates an elevational view of the lid of FIGS. 5 and 6;

FIG. 8 illustrates a top plan view of the lid of FIGS. 5-7;

FIG. 9 illustrates an elevational view of an alternative embodiment of the infuser of FIGS. 1-4;

FIG. 10 illustrates a cross-sectional elevational environmental view of the retrofit infuser of FIGS. 1-4, showing the retrofit infuser in a bottle;

FIG. 11 illustrates a cross-sectional top perspective environmental view of the retrofit infuser of FIGS. 1-4 showing the retrofit infuser in a bottle similar to FIG. 10;

FIG. 12 illustrates a top perspective environmental view of the retrofit infuser of FIGS. 1-4 showing the retrofit infuser in a bottle similar to FIGS. 10 and 11;

FIG. 13 illustrates a top plan environmental view of the retrofit infuser of FIGS. 1-4 showing the retrofit infuser in a bottle similar to FIGS. 10-12;

FIG. 14 illustrates a bottom perspective view of an alternative embodiment of a cage of the infuser of FIGS. 1-4 configured to be used in association with a drinking container having a straw;

FIG. 15 illustrates a bottom perspective view of the cage of FIG. 14 having a straw inserted through an upper portion thereof;

FIG. 16 illustrates a bottom perspective view of the cage of FIGS. 14 and 15 with a straw removably secured therein;

FIG. 17 illustrates a bottom perspective environmental view of the cage of FIGS. 14-16 having a straw removably secured therein and being removably secured within a lid of a drinking container;

FIG. 18 illustrates a top perspective view of an alternative embodiment of a lid of the infuser of FIGS. 1-4;

FIG. 19 illustrates a front elevational view of the lid of FIG. 18 being identical to the back elevational view;

FIG. 20 illustrates a side elevational view of the lid of FIGS. 18 and 19, the left and ride side views being the same; and

FIG. 21 illustrates a bottom perspective view of the lid of FIGS. 18-20.

### DETAILED DESCRIPTION OF THE PREFERRED EMBODIMENTS

As shown in the drawings and for purposes of illustration, the one or more embodiments disclosed herein illustrate a retrofit infuser, generally referred to herein by the reference numeral 10. Generally, the infuser 10 may be removably secured in a variety of water bottles and drinking containers known in the art, such as wide-mouthed drinking containers, drinking containers having a foldable spout and straw, drinking containers wherein the straw extends out of the lid, etc. Alternatively, the infuser 10 may be inserted loosely within a drinking container. The infuser 10 may be generally comprised of a cage 12 and a lid 14. The lid 14 may be removably securable and attachable to the cage 12. The cage 12 may be generally configured to hold material to be infused into a liquid of a drinking container such as fruit, vegetables, herbs, teas, coffee beans, coffee grounds, or other food and/or drink related material. The cage 12 may be further configured to allow the material to be infused to mix with water or other liquid such that the flavors and other extractable soluble constituents and principles of the material infuse with the water or other liquid. The lid 14 may be configured to removably secure the infuser 10 within a drinking container, while at the same time suspending the cage 12 within the drinking container. Alternatively, the lid 14 may be configured to provide the infuser 10 with enough buoyancy to float above the bottom of the drinking container. The infuser 10 may be configured such that when it is secured or placed in a drinking container, a lid of the drinking container may still be removably attached to the drinking container.

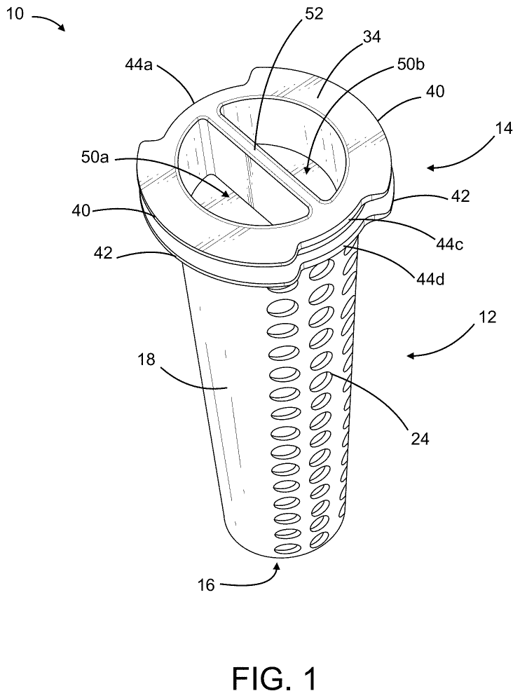

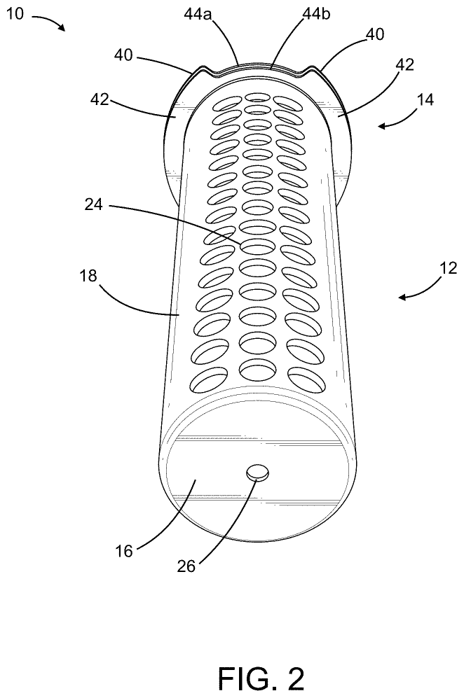

With reference now to FIGS. 1-2, various features of the infuser 10 are illustrated. As mentioned above, the infuser 10 may be comprised of a cage 12 and a lid 14 wherein the lid 14 may removably secure and attach to the cage 12. The cage 12 may be generally cylindrical or disc-like in shape but is not limited to this shape and may be made in a variety of different shapes and sizes. The cage 12 may further be made of a sturdy and rigid food-grade material. For example, the cage 12 may be made of a hard polymer such as plastic, a metal such as stainless steel, or some other sturdy and rigid food-grade material known in the art. The lid 14 may be made of a softer and more flexible, yet still durable, food grade material such as a softer plastic, silicone, or other softer and flexible food grade material known in the art. In some embodiments, the lid 14 may alternatively be made of the same material as the cage 12.

With reference now to FIGS. 1-3, the cage 12 may be comprised of a hollow body being comprised of a base 16, a lateral surface 18, and a rim 20. As described above, the cage 12 may be generally cylindrical in shape with the base 16 forming the bottom of the cage 12, the lateral surface 18 forming the sides of the cage 12 and making up the length of the cage 12, and the rim 20 forming the top of the cage 12. However, the cage 12 may be in a variety of different shapes and is not limited to a cylindrical shape. For example, in one embodiment, the cage 12 may be in the shape of a truncated cone wherein the diameter of the rim 20 is only slightly larger than the diameter of the base 16.

Generally, the base 16 and the lateral surface 18 may define an inner compartment 22 of the cage and the rim 20 may define an opening to the compartment 22. The compartment 22 may be configured to receive and hold material to be infused such as cut pieces of fruit, cut pieces of vegetables, tea bags, coffee beans, coffee grounds, other food and/or drink related material, and mixtures of the same which may be placed into the compartment 22 through the opening defined by the rim 20. The lateral surface 18 of the cage 12 may be comprised of a plurality of apertures 24 which allow water or other liquid from a water bottle or liquid container to mix with the contents of the cage 12 within the compartment 22. The base 16 may also be comprised of at least one aperture 26 that further allows water or other liquid to mix with the contents of the cage 12.

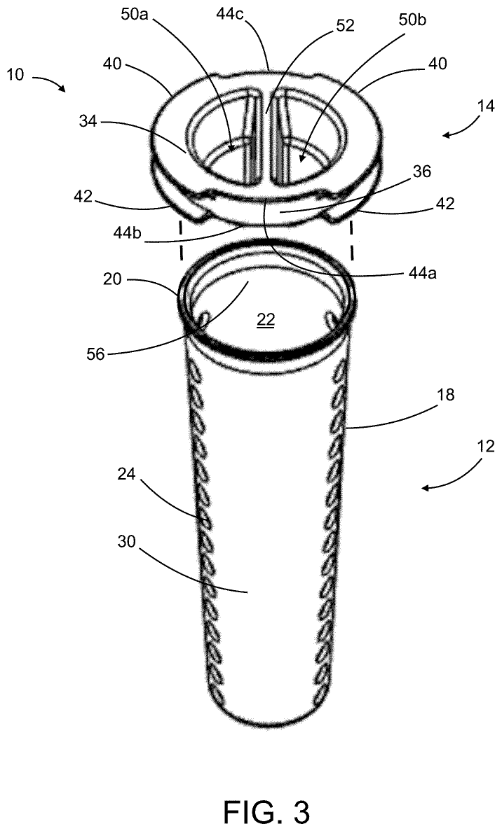

With reference now specifically to FIG. 3, the rim 20 of the cage 12 may be thicker than the lateral surface 18 of the cage 12 and may be in the shape of a circular ring wherein the vertical cross sections of the rim 20 form circles. The lid 14 may be comprised of a rim crevice 38 (best seen in FIG. 6) which is configured to receive the rim 20 such that the rim 20 of the cage 12 may be removably secured to the bottom of the lid 14.

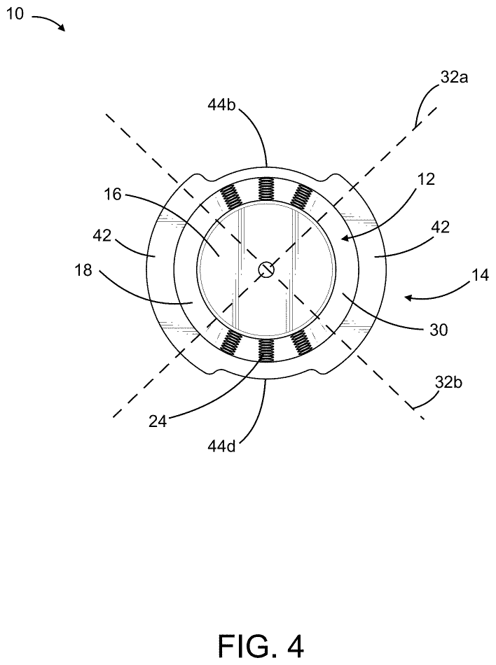

With reference now to FIG. 4, a bottom plan view of one embodiment of the retrofit infuser 10 is illustrated. In this embodiment, the lateral surface 18 of the cage 12 may be comprised of sections comprised of a plurality of apertures 24 and sections of smooth wall 30 with no apertures. Dashed lines 32a and 32b illustrate that the lateral surface 18 of the cage 12 may be divided into four equally sized sections wherein two of the sections may be comprised of a plurality of apertures 24 and two of the sections may be smooth walls 30 with no apertures. In this embodiment, it is preferable that the two sections comprised of a plurality of apertures 24 are not adjacent to one another, but rather across from one another as illustrated in FIG. 4.

In another embodiment, the lateral surface 18 of the cage 12 may be completely covered in apertures 24 with no smooth walls 26. In other embodiments, the lateral surface 18 may only be comprised of a single section of apertures 24 and mostly comprised of smooth walls 30. In other embodiments, the cage 12 may be completely comprised of a wire or stainless steel mesh having a plurality of apertures and a rim 20 that removably secures within the lid 14 as described above.

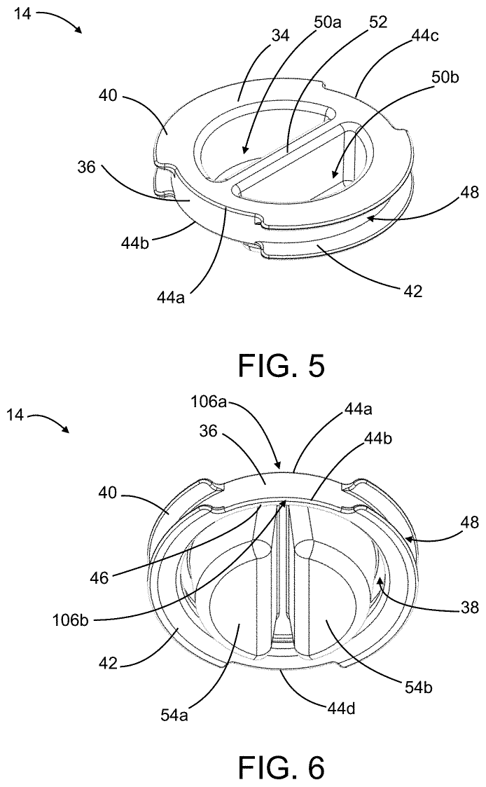

With reference now to FIGS. 1-8, the lid 14 may be comprised of a top surface 34, an outer lateral surface 36 and a rim crevice 38. The lid 14 may generally be circular or disc-like in shape when viewing the lid 14 from the top as best shown in FIG. 8 but is not limited to a circular configuration. Generally, the shape of the lid 14 may be congruent with the shape of a rim and neck of a water bottle or liquid container in which the retrofit infuser 10 is used. As previously described above, the rim crevice 38 of the lid 14 may be configured to receive the rim 20 of the cage 12 such that the rim 20 is removably secured in the rim crevice 38. More specifically, the rim crevice 38, may be an indent in the shape of a circular ring locate on the bottom of the lid 14 such that the rim 20 may be pressed into the rim crevice 38 and removably secured therein.

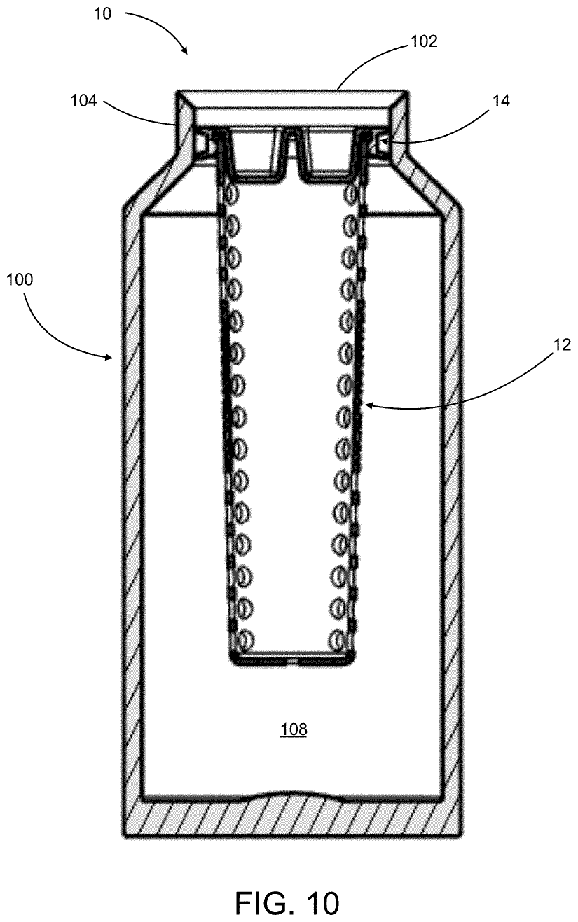

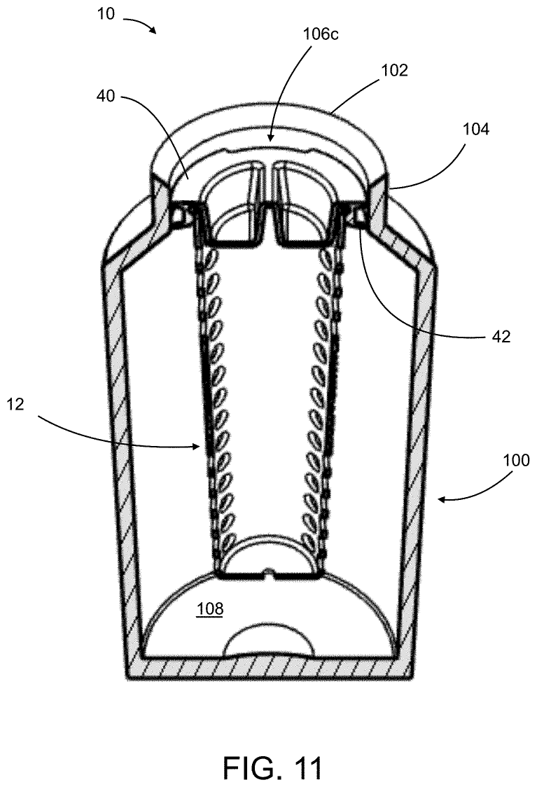

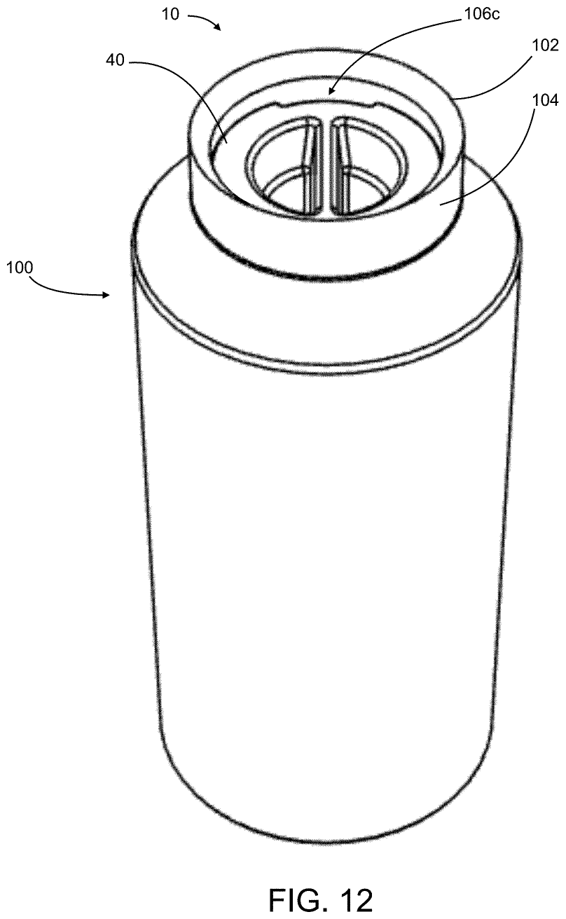

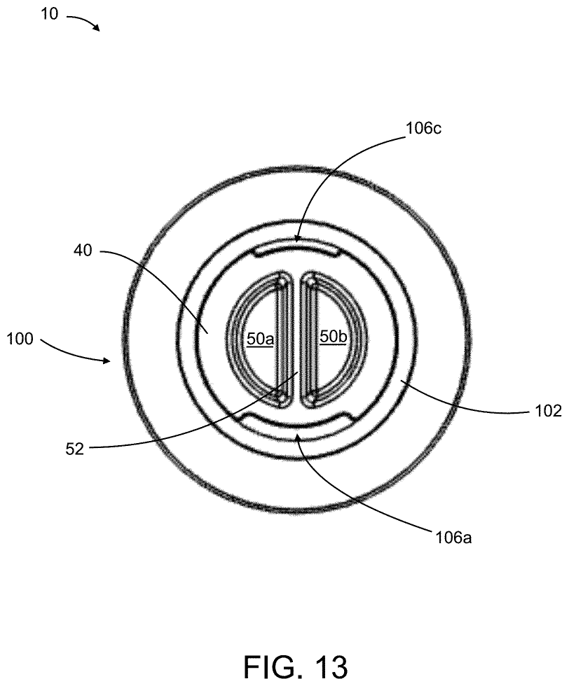

The lid 14 may further be comprised of at least one securing flap 40. The at least one securing flap 40 may extend outwardly from and orthogonally to the lateral surface 36 of the lid 14. The at least one securing flap 40 may be generally in the same shape as the lid 14 extending around the lateral surface 36. As best seen in FIGS. 10-13, the at least one securing flap 40 may be slightly larger than a rim 102 of a liquid container 100. Thus, when the lid 14 is inserted into a neck 104 of a liquid container 100, the at least one securing flap 40 will slightly bend upward and create a force against the neck 104 of the neck 104 of the liquid container 100 so as to removably secure the retrofit infuser 10 within the liquid container 100.

The lid 14 may further be comprised of at least one notch 44. The at least one notch 44 may be positioned in the at least one securing flap 40 such that when the retrofit infuser 10 is pressed and removably secured within the neck 104 of a liquid container 100, the at least one notch 44 leaves open a spout 106, as best seen in FIGS. 10-13 between the lid 14 and the neck 104 of the liquid container.

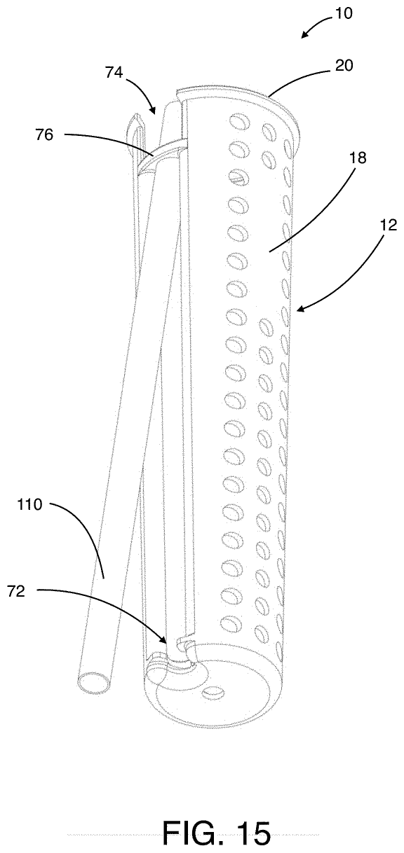

As alluded to above in the description of the lid 14, the lid 14 may be comprised of more than one securing flap 40 and may further be comprised of more than one notch 44. For example, in one embodiment, the lid 40 may be comprised of an upper securing flap 40 and a lower securing flap 42. The upper securing flap 40 and the lower securing flap 42 may both extend outwardly from and orthogonally to the lateral surface 36 of the lid 14 such that the upper securing flap 40 is above the lower securing flap 42. This arrangement may allow for more force to be exerted against the neck 104 of a liquid container 100 to further removably secure the retrofit infuser 10 within the liquid container 100. In this arrangement, the upper securing flap 42 may be flush with the top surface 34 of the lid 14 and the lower securing flap 42 may be flush with a bottom ring 46 of the lateral surface 36 of the lid 14. In this embodiment, the upper securing flap 40 and the lower securing flap 42 may define a canal 48 running laterally around the lid. Furthermore, this embodiment may be comprised of an upper notch 44a and a lower notch 44b. The upper notch 44a may be positioned within the upper securing flap 40 so as to form an upper spout 106a when the retrofit infuser 10 is removably secured within a liquid container 100 as described above. The lower notch 44b may similarly be positioned within the lower securing flap 42 to similarly form a lower spout 106b. The upper and lower notches 44a and 44b may be directly above and below one another respectively such that they are aligned when looking from the top down as best seen in FIG. 15.

In another embodiment, the lid 40 may be comprised of one securing flap 40, which may extend outwardly from and orthogonally to the lateral surface 36 of the lid 14, similar to what has been described above. The lid 40 may further be comprised of a large notch 44a and a small notch 44c. The large notch 44a and the small notch 44c may be positioned in the securing flap 40 such that when the retrofit infuser 10 is pressed and removably secured within a neck 104 of a liquid container 100, the large notch 44a and the small notch 44c both leave open a large spout 106a and a small spout 106c respectively, as best seen in FIGS. 10-13, between the lid 14 and the neck 104 of the liquid container 100. The large notch 44a and the small notch 44c may be opposite each other so as to be directly across from each other on the lid 14 such that the large notch 44a and the small notch 44c divide the securing flap 40 into two equally sized sections 40a and 40b.

In yet another embodiment, the lid 14 may be comprised of an upper securing flap 40, a lower securing flap 42, a large upper notch 44a, a large lower notch 44b, a small upper notch 44c and a small lower notch 44d. The upper securing flap 40 and the lower securing flap 42 may both extend outwardly from and orthogonally to the lateral surface 36 of the lid 14 such that the upper securing flap 40 is above the lower securing flap 42 as described above. This embodiment with upper and lower securing flaps 40 and 42 will provide more force against the neck 104 of the liquid container 100 so as to more firmly removably secure the infuser 10 within the liquid container 100. Similar to the embodiments described above, the large upper notch 44a and the small upper notch 44c may be positioned in the upper securing flap 40 such that when the infuser 10 is pressed and removably secured within a neck 104 of a liquid container 100, the large upper notch 44a and the small upper notch 44c both leave open a large upper spout 106a and a small upper spout 106c within the upper securing flap 40 respectively, as best seen in FIGS. 10-13, between the lid 14 and the neck 104 of the liquid container 100. Similarly, the large lower notch 44b and the small lower notch 44c may be positioned in the lower securing flap 42 such that when the retrofit infuser 10 is pressed and removably secured within the neck 104 of the liquid container 100, the larger lower notch 44b and the small lower notch 44d both leave open a large lower spout 106b and a small lower spout 106d within the lower securing flap 42 respectively, between the lid 14 and the neck 104 of the liquid container 100.

In this embodiment, the large upper notch 44a and the small upper notch 44c may be opposite each other so as to be directly across from each other on the lid 14 such that the large upper notch 44a and the small upper notch 44c divide the upper securing flap 40 into two equally sized sections 40a and 40b. In addition, the large lower notch 44b and the small lower notch 44d may also be opposite each other so as to be directly across from each other on the lid 14 such that the large lower notch 44b and the small lower notch 44d divide the lower securing flap 42 into two equally sized sections 42a and 42b. The large upper notch 44a and the large lower notch 44b may be directly above and below one another respectively such that they are aligned when viewing the lid 14 from the top. Similarly, the small upper notch 44c and the small lower notch 44d may also be directly above and below one another respectively such that they are aligned when viewing the lid 14 from the top.

The lid 14 may further be comprised of at least one finger indent 50. The at least one finger indent 50 may recede into the top surface 34 of the lid 14 so as to form a pit in which a finger of the user can be inserted. In one embodiment, the lid 14 may be comprised of two finger indents 50a and 50b, and a handle 52. As mentioned above, the finger indents 50a and 50b may recede into the top surface 34 of the lid 14 to form pits in which fingers of the user can be inserted. The finger indents 50a and 50b may be shaped such that horizontal cross-sections of the finger indents 50a and 50b are in the shape of a half-circle and positioned such that the straight edge or diameter of the half circle of the first finger indent 50a faces the straight edge or diameter of the half circle of the second finger indent 50b. However, the finger indents 50a and 50b may be in any shape that would accommodate a finger of the user. The handle 52 of the lid 14 may be located directly between the first and second finger indents 50a and 50b. More specifically, the handle 52 may be defined by the walls of the straight edges or diameters of the finger indents 50a and 50b as shown in the figures.

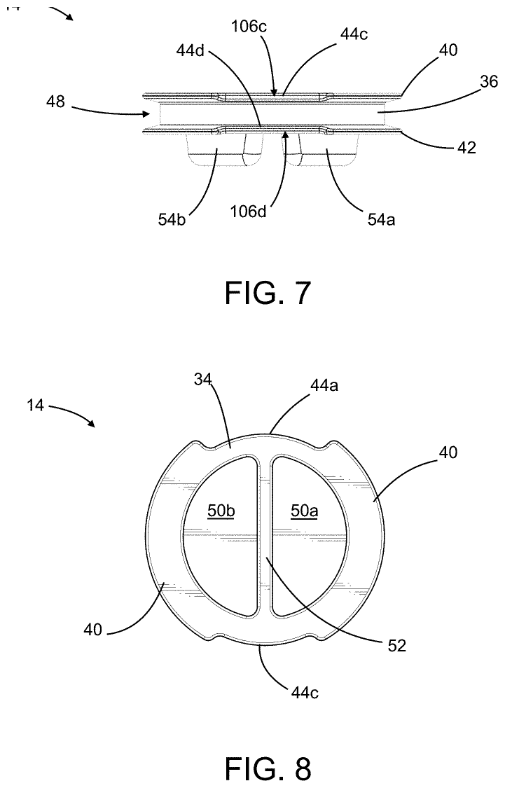

With reference now specifically to FIGS. 6 and 7, the underside of the lid 14 is illustrated. The lid may be comprised of a bottom ring 46 which may be the bottom surface of the lateral surface 36 of the lid 14. The bottom ring 46 may have a slightly smaller diameter than the rim 20 of the cage 12. The lid may be further comprised of a rim crevice 28 as described above which is located superiorly to the bottom ring 46 and configured to receive the rim 20 of the cage 12. When the lid 14 is inserted onto the cage 12, the bottom ring 46 may stretch over the rim 20 of the cage 12 when the rim 20 of the cage 12 is pushed into the rim crevice 28. The bottom ring 26 may then fit snuggly around the top of the lateral surface 18 of the cage 12. In this manner, the lid 14 may be removably secured and attached to the cage 12.

The lid 14 may further be comprised of one or more securing mounds 54a and 54b. The securing mounds 54a and 54b may be formed by the finger indents 50a and 50b. In other words, the securing mounds 54a and 54b may be the underside of the finger indents 50a and 50b. The securing mounds 54a and 54b may be configured to insert partially into the compartment 22 of the cage 12 and to push against an inner wall 56 of the cage 12 when the lid 14 is removably secured to the cage 12. The securing mounds 54a and 54b will thus act to further secure the lid 14 when it is attached to the cage 12 as described above.

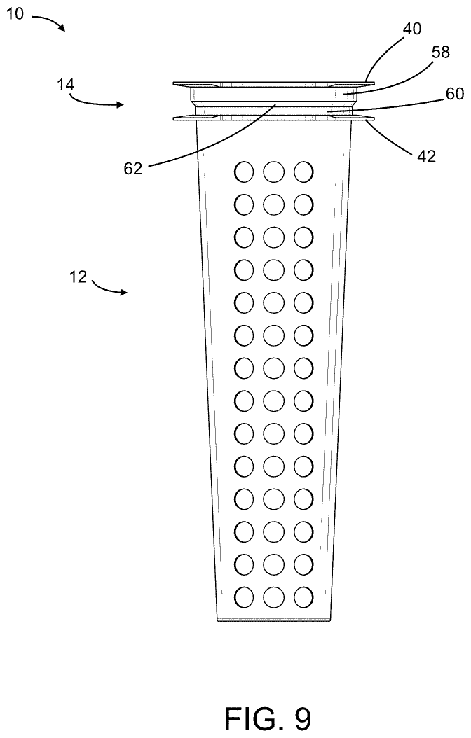

With reference now to FIG. 9, in one embodiment of the infuser 10 the lateral surface 36 of the lid 14 may be comprised of an upper surface 58, a lower surface 60 and an adapting surface 62 which may be located between the upper surface 58 and the lower surface 60. Horizontal cross-sections of the upper surface 58, the lower surface 60 and the adapting surface 62 may be in the shape of circles. The diameter of the upper surface 58 may be uniform and larger than the diameter of the lower surface 60 which may also be uniform. The diameter of the adapting surface 62 may be the same size of the diameter of the lower surface 60 where the adapting surface 62 meets the upper surface 58 and gradually increase until the diameter is the same size as the diameter of the upper surface 60 where the adapting surface 62 meets the upper surface 58. This configuration of the lateral surface 36 of the lid 14 may assist in helping provide a smooth flow of liquid through the spouts 106.

With reference now specifically to FIGS. 10-13, environmental views of the infuser 10 are illustrated showing the infuser 10 removably secured in a water bottle or liquid container 100. As can be seen in the figures, liquid containers 100 known in the art are commonly comprised of a rim 102, a neck 104 and a compartment 108 configured to receive and hold water or some other drinkable liquid. The infuser 10 may be removably secured within the neck 104 of the liquid container 100 such that the top surface 34 of the lid 14 is proximate with the rim 102 of the liquid container 100. More specifically, the lid 14 of the infuser 10 may be removably secured within the neck 104 of the liquid container 100 such that the top surface 34 of the lid 14 is proximate with the rim 102 of the liquid container 100 and such that the cage 12 of the infuser 10 is suspended within the compartment 108 of the liquid container 100.

The retrofit infuser 10 may be removably secured within the liquid container 100 by a number of forces. More specifically, the lid 14 of the retrofit infuser 10 may exert a spring type force against the inner wall of the neck 104 of the liquid container 100. As described above, the at least one securing flap 40 may be slightly larger in diameter than the rim 104 of the liquid container 100. Thus, when the lid 14 of the infuser 10 is pressed into the neck 104 of the liquid container 100, the at least one securing flap 40 may be displaced slightly upwardly from its normal position and thus exerting a normal force against the inner wall of the neck 104 of the liquid container 100. This normal force acts to removably secure the infuser 10 within the liquid container 100. As described above, the lid 14 may be comprised of additional securing flaps 40 and 42 to apply more force against the inner wall of the neck 104 of the liquid container 100 to better removably secure the infuser 10 within the liquid container 100.

In addition to this spring type normal force, the lid 14 of the infuser 10 may be made from a material with a high coefficient of friction in relation to the inner wall of the neck 104 of the liquid container 100. As described above, when the lid 14 of the infuser 10 is removably secured within the liquid container 100, the at least one securing flap 40 may be pressed against the inner wall of the neck 104 of the liquid container 100. In this position, a static frictional force may be present between the at least one securing flap 40 of the infuser 10 and the inner wall of the neck 104 of the liquid container 100. This static frictional force may further help in removably securing the infuser 10 within the liquid container 100. As described above, the lid 14 may be further comprised of additional securing flaps 40 in which an additional static frictional force may be present between each additional securing flap 40 and the inner wall of the neck 104 of the liquid container which would further help in removably securing the retrofit infuser 10 within the liquid container 100.

In alternative embodiments, the lid 14 of the infuser 10 may not be comprised of securing flaps 40 but may be comprised of a plurality of protruding bumps on the lateral surface 36 of the lid 14. Alternatively, the lid 14 may be comprised of a pattern of protruding crosshatches on the lateral surface 36 of the lid 14. In other words, the lateral surface 36 of the lid 14 of the infuser 10 may be comprised of at least one securing flap 40, protruding bumps, protruding crosshatches, some other protruding pattern or a combination of the like, such as a combination of a securing flap and plurality of protruding bumps, a combination of protruding bumps and protruding crosshatches, etc. In each of these various embodiments, the protruding bumps, protruding crosshatches, some other protruding pattern, etc. may each be compressible against the inner wall of the neck 104 of the liquid container 100 such that they apply a uniform normal force against the inner wall of the neck 104 of the liquid container 100 and such that static frictional forces are still present between the protruding bumps, protruding crosshatches, some other protruding pattern, etc. and the inner wall of the neck 104 of the liquid container 100. In these alternative embodiments, the lateral surface 36 of the lid 14 may further be comprised of at least one notch, similar to what was described above for the at least one notch 44 of the at least one securing flap 40, such that the at least one notch forms at least one spout when the lid 14 is secured within the neck 104 of the liquid container 100 such that water or some other liquid may be poured from the liquid container 100.

In yet another alternative embodiment, the lid 14 of the infuser 10 may be configured such that the lateral surface 36 of the lid 14 may press against an inner wall of the neck 104 of the liquid container 100 such that the infuser 10 is removably secured within the liquid container. In this embodiment, the lateral surface 36 of the lid 14 may further be comprised of at least one notch, similar to what was described above for the at least one notch 44 of the at least one securing flap 40, such that the at least one notch forms at least one spout when the lid 14 is secured within the neck 104 of the liquid container 100 such that water or some other liquid may be poured from the liquid container 100.

In another embodiment, the lid 14 of the infuser 10 may be comprised of an outer rim, a lateral surface, an inner lip and an opening. The lateral surface may be circular in shape and have a height similar to the height of a neck 104 of a water bottle or liquid container 100 in which the lid 14 is inserted. The outer rim of the lid 14 may be positioned on top of the later surface. The rim may be flat and create a ledge that projects away from the lateral surface. The rim of the lid 14 may be configured to rest on top of the rim 102 of the liquid container 100 such that the lid 14 may be secured within the neck 104 of the liquid container 100. The rim of the lid 14 may be narrow enough such that a lid of the liquid container 100 may still close over the liquid container 100. The inner lip may be located on the bottom of the lateral surface and create a ledge projecting inwardly from the lateral surface. The inner lip may only project slightly inwardly and thus leave an opening in which a cage 12 may be inserted. In this embodiment, the rim 20 of the cage 12 may be configured as a flat ring forming an outer ledge around the top of the cage 12. In this configuration, the rim 20 of the cage may rest on the inner lip of the lid 14 such that the cage 12 is suspended within the liquid container. The lateral surface of the lid 14, may further be configured to be very thin in thickness such that a lid of a liquid container 100 with an insulating projection may still securely close over the liquid container with the retrofit infuser 10 within the container 100. In this embodiment, the main body of the cage 12 may be configured of a fine food-grade steel mesh so as to hold coffee beans or coffee grounds without the grounds escaping from the cage 12, but still allowing liquid in the cage to mix with the contents of the cage 12. This embodiment may be beneficial for longer time periods to infuse, such as an overnight infusion in which the retrofit infuser 10 is removed before consuming the liquid.

In each of the alternative embodiments above, the lid 14 of the retrofit infuser 10 may vary in size so as to fit various sizes of water bottles and liquid containers 100. For example, the lid 14 may be larger to work in connection with widemouthed water bottles or liquid containers. Alternatively, the lid 14 may be smaller to work in connection with more narrow-mouthed water bottles or liquid containers. The size of the cage 12 may also vary to work in different sizes of water bottles and liquid containers such that the cage 12 may hold more contents in larger bottles and liquid containers or be smaller to work in smaller bottles and liquid containers.

In yet another embodiment, the infuser 10 may be configured for use in a drinking container having a straw. In this embodiment, the infuser 10 may be comprised of a cage 12 and a lid 14. The lid 14 may be similar to embodiments described above but may also be comprised of an aperture in the top surface 34 of the lid 14 which runs through the lid 14. The aperture may be configured to receive the straw of the water bottle or liquid container and to allow the straw to fit through the retrofit infuser 14 when the lid of the drinking container is removably attached to the water bottle or drinking container. In the alternative, instead of being comprised of an aperture, the lid 14 may be comprised of a bay which recedes into the at least one securing flap 40 and into the lateral surface 36 of the lid 14. The bay may be configured to allow the straw of a drinking container to still fit into the drinking container when the infuser 10 is in use.

In this embodiment, the cage 12 may be further comprised of a straw aperture in its base 16 such that the straw can pass through the cage 12 and still fit into the drinking container when the infuser 10 is in use. Alternatively, the cage 12 may be comprised of a straw aperture in its lateral surface 18 such that the straw can pass through the cage 12 and still fit into the water bottle or liquid container when the retrofit infuser 10 is in use. In yet another alternative, the cage 12 may be comprised of a tube which may be comprised of a first end and a second end. The first end of the tube may be secured to the rim 20 of the cage 12 and the second end of the tube may be secured through the base 16 of the cage 12. The first end may be flush with the rim 20 and the second end may be flush with the base 16 but may also extend past the base 16. The tube maybe configured to align with the aperture or bay of the lid 14 such that the straw may fit through the aperture or bay of the lid 14 and through the tube of the cage 12 such that the straw may still fit in the water bottle or liquid container when the retrofit infuser 10 is in use.

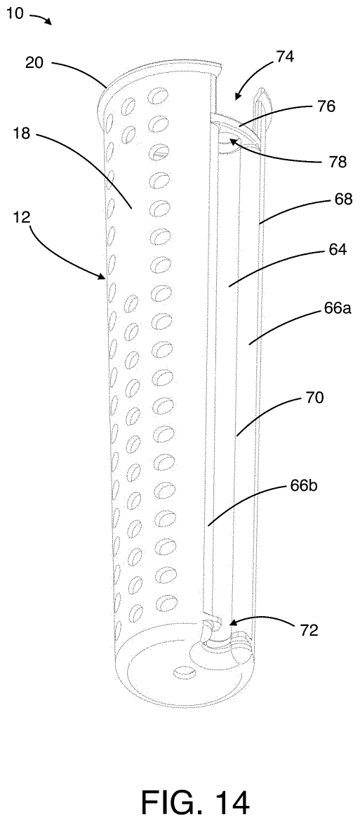

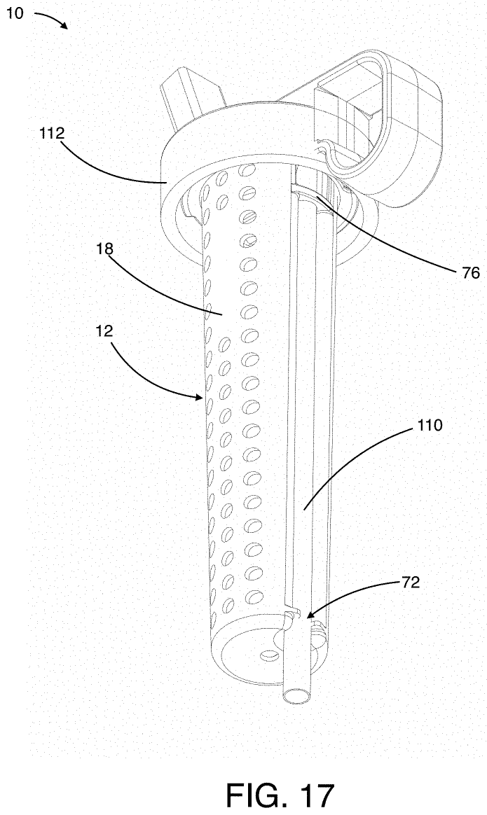

In yet another alternative embodiment, as best seen in FIGS. 14-17, the infuser 10 may be comprised of a cage 12. The cage may be comprised of a channel 64 which may run vertically along the length of the lateral surface 18 of the cage 12 and a rim 20 defining an opening to the compartment 22 as described above. The channel 64 may run completely along the entire length of the lateral surface 18. The channel 64 may be configured to receive a straw 110 of the drinking container such that the straw 110 of the drinking container may be removably securable within the channel 64 such that the straw 110 may still fit in the drinking container when the infuser 10 is in use. For example, a cross-section of the channel 64 made orthogonally to its length may be in the shape of an uncompleted circle having an opening into the circle. The uncompleted circle may be larger than a halfway completed circle. In this manner, a straw 110 may be snapped and removably secured within the channel 64.

The cage 12 of the infuser 10 may further include curbs 66a and 66b running along both sides of the length of the channel and the lateral surface 18 such that a smooth transition is made between the lateral surface 18 and the channel 64. The curbs 66a and 66b may have a lateral surface edge 68 and a channel edge 70. The lateral surface edge 68 may be adjacent to and run along the length of the lateral surface 18. The channel edge 70 may be adjacent to and run along the length of the channel 64. The curbs 66a and 66b may be curved between their respective lateral surface edges 68 and their channel edges 70 so as to create a smooth transition between the lateral surface 18 and the channel 64.

The cage 12 of the infuser 10 may include a clip 72 configured to removably secure the straw 110 of the drinking container to the cage 12. In embodiments without the channel 64, the clip 72 may be located on the lateral surface 18 of the cage 12. In embodiments with the channel 64, the clip 72 may be positioned within the channel 64. For example, the clip 72 may extend the cross-section of the channel 64 described above such that the partial circle is closer to being completed at the clip 72 than it is at other portions of the channel 64. In this manner, the straw 110 may be pressed down through the clip 72 and removably secured by the clip 72 within the channel 64. The clip 72 may be positioned at the opposite end of the channel 64 as rim 20. In alternative embodiments, more than one clip may be positioned within the channel 64.

The cage 12 of the infuser 10 may further include a notch 74. The notch 74 may be positioned through the rim 20 and extending into the lateral surface 18. The notch 72 may end at one end of the channel 64. The notch 74 may assist with placement of the cage 12 within a lid of a drinking container. The cage 12 may further include a wall 76 running orthogonally to the channel 64 and separating the channel 64 from the notch 74. The wall 76 may include an aperture 78 aligned with the channel 64 such that a straw 110 may be inserted through the aperture 78 and into the channel 64. The wall 76 may be positioned at an opposite end of the channel 64 as the clip 72. In this manner, the wall 76 and the clip 78 may work together to removably secure the straw 110 within the channel 64.

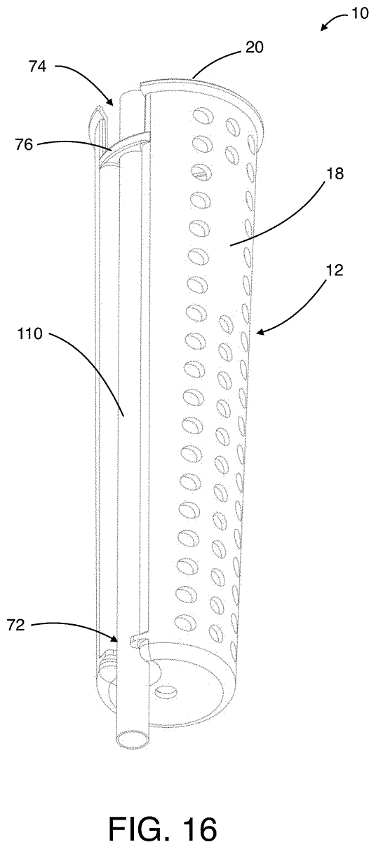

With reference now specifically to FIGS. 15-17, a manner of removably securing a straw 110 of a drinking container to the infuser 10 is shown. For example, as shown in FIG. 15, the straw 110 may be inserted through the aperture 78 of the wall 76 and pushed through the aperture 78 such that an end of the straw 110 passes the base 16 of the cage 12. Once an end of the straw 110 passes the base 16 of the cage 12, the straw 110 may be pushed down through the clip 72 and removably secured within the channel 64 as shown in FIG. 16. In this manner, the cage 12 may be removably secured within a lid 112 of the drinking container with the straw removably secured within the channel 64 such that an end of the straw passes the base 16 of the cage 12.

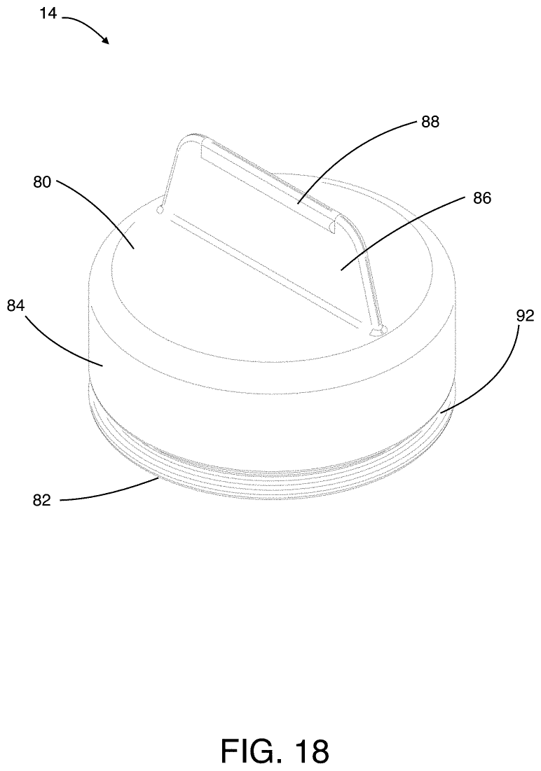

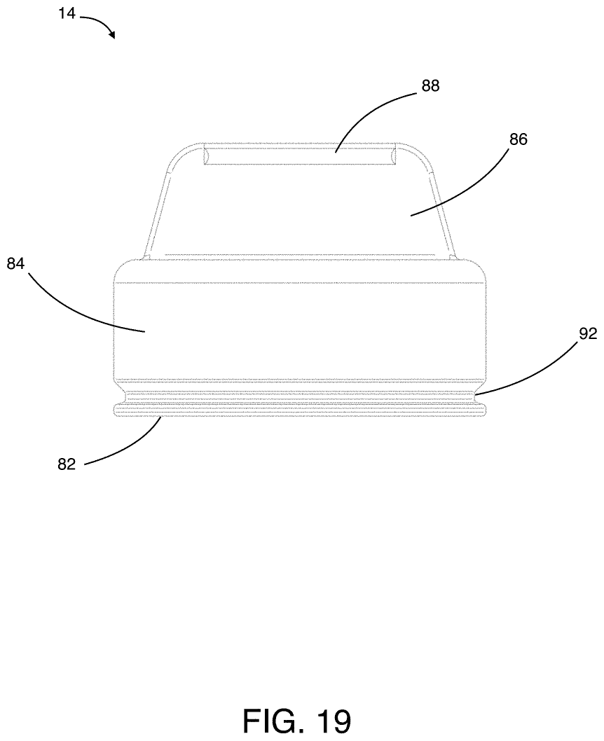

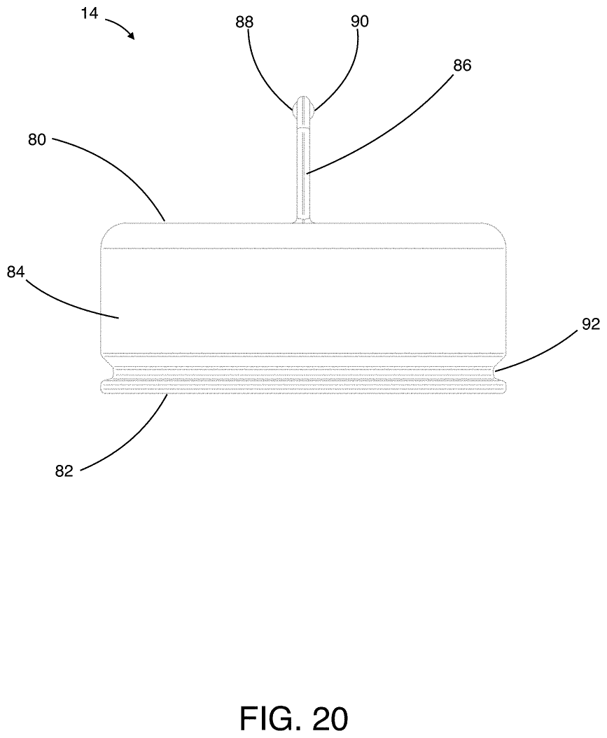

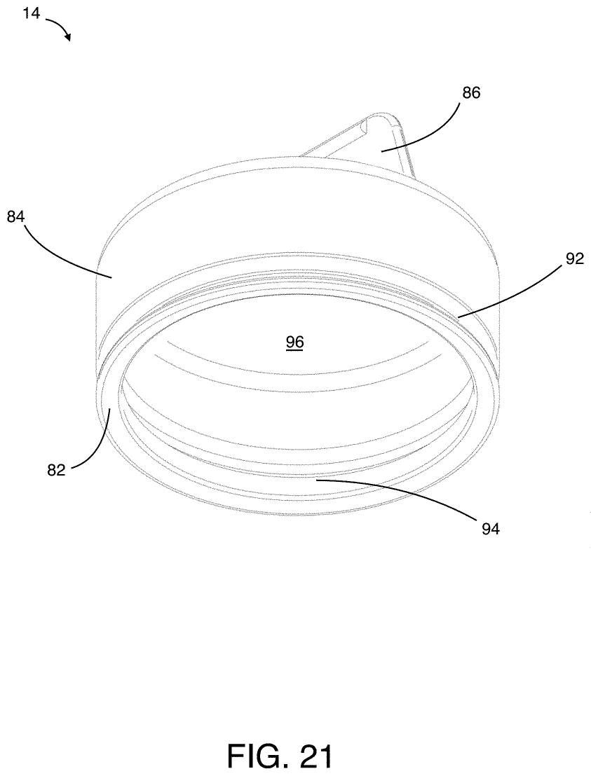

With reference now specifically to FIGS. 18-21, an alternate embodiment of a lid 14 of the infuser 10 is best shown. In this embodiment, the lid 14 may function to provide enough buoyancy to be able to allow the lid 14 to float atop the liquid inside a drinking container while suspending the cage 12 and any contents in the cage 12 above the bottom of the drinking container such that the cage is submerged and the contents may infuse into the liquid. In this embodiment, the lid 14 may be generally circular in shape and may be comprised of a top 80, a bottom rim 82 and an outer lateral surface 84 having a length between the bottom rim 82 and the top 80. The lid 14 may further be comprised of a handle 86. The handle 86 may be configured for a user to grasp. The handle 86 may extend upward from the top 80 of the lid 14. The handle 86 may be flat, may be textured, or may be arched so as to assist a user in grasping the handle 14. In some embodiments, the handle 86 may have a bump-like protuberance 88 extending lengthwise across the top of the handle 14. A second bump-like protuberance 90 may be similarly positioned on the opposite side of the handle 14. The bump-like protuberances 88 and 90 may help a user to more easily grip the handle 86.

The lid 14 may be comprised of a channel 92. The channel may go around a circumference of the outer lateral surface 84 such that a diameter at the bottom of the channel 92 going around the outer lateral surface 84 may be smaller than the diameter of the outer lateral surface 84 itself. The channel 86 may function to create a bump 94 going completely around the inside of the lid 14. The bump 94 may function such that when the rim 20 of the cage 12 is pushed into the bottom of the lid 14, the rim may rest on top of the bump such that it is removably secured within the lid 14. The channel 92 may preferably be located near the bottom of the outer lateral surface 84 of the lid 14 such that it is proximate to the bottom rim 82 of the lid 14.

The lid 14 may further comprise a chamber 96 defined by the top 80 and the outer lateral surface 84 of the lid 14. An opening to the chamber 96 may be defined by the bottom rim 82 of the lid 14. When the rim 20 of the cage 12 is removably secured within the bottom of the lid 14, the chamber 96 of the lid 14 may function to trap air inside as the infuser 10 is placed into liquid inside a drinking container. The trapped air in the chamber 96 of the lid 14 may function to provide enough buoyancy to the infuser 10 such that the lid 14 of the infuser 10 may float on top of the liquid in the drinking container while the cage 12 and its contents are suspended within the liquid. In this manner, the infuser 10 may easily be placed within a drinking container such as a mug, cup, wide rimed bottle, etc. to infuse its contents into the liquid of the drinking container.

Although several embodiments have been described in detail for purpose of illustration, various modifications may be made without departing from the scope and spirit of the invention. Accordingly, the invention is not to be limited except as by the appended claims.

What is claimed is:

1. An infuser comprising:
a lid being generally disc-like in shape and being comprised of a top, a bottom, an outer lateral surface, and a flap extending outward from the outer lateral surface of the lid such that when the lid is inserted into a neck of a drinking container, the flap pushes against an inner wall of the neck; and
a cage comprised of a hollow body and a chamber, the hollow body being comprised of a rim and a plurality of apertures extending through the hollow body and the chamber being configured to hold material to be infused within the cage and being defined by the hollow body with an entrance to the chamber being defined by the rim, wherein the rim may be removably secured within the bottom of the lid.

2. The infuser of claim 1, wherein the flap extends completely around and outward from a circumference of the outer lateral surface.

3. The infuser of claim 2, wherein the flap is comprised of a notch such that the notch forms a spout when the lid is inserted into the neck of the drinking container.

4. The infuser of claim 3, wherein the flap is further comprised of a secondary notch also forming a spout when the lid is inserted into the neck of the drinking container, wherein the secondary notch is located on the opposite side of the flap from and smaller than the notch.

5. The infuser of claim 1, wherein the lid is comprised of two flaps, both flaps extending outward from the outer lateral surface, wherein one flap is located inferiorly to the other.

6. The infuser of claim 3, wherein the lid is comprised of two flaps being identical to each other, wherein one flap is located inferiorly to the other.

7. The infuser of claim 4, wherein the lid is comprised two flaps being identical to each other, wherein one flap is located inferiorly to the other.

8. The infuser of claim 1, wherein the lid is further comprised of a mound extending from the bottom of the lid, such that when the rim is removably secured within the lid, the mound extends within the chamber.

9. The infuser of claim 8, wherein the lid is comprised of a handle.

10. An infuser comprising:
a cage comprised of a hollow body and a chamber, the cage being configured to removably secure to a drinking straw of a drinking container, the hollow body being comprised of a plurality of apertures extending through the hollow body and a clip exposed on the exterior of the hollow body and the chamber being defined by the hollow body and being configured to hold material to be infused within the cage; and
wherein the drinking straw may be removably secured within the clip of the cage such that the cage may be suspended from the straw within the drinking container.

11. The infuser of claim 10, wherein the cage is further comprised of a rim being configured to fit within a bottom of a lid of the drinking container.

12. The infuser of claim 10, wherein the cage is further comprised of a channel running through a length of the hollow body of the cage and being configured to receive the straw.

13. The infuser of claim 12, wherein the clip is located within the channel of the hollow body and configured such that the straw may be removably secured within the channel.

14. The infuser of claim 12, wherein the cage is further comprised of a rim being configured to fit within a bottom of a lid of the drinking container, a notch within the rim located at one end of the channel, and a wall having an aperture and being parallel to the rim and dividing the notch from the channel, wherein the aperture of the wall may be configured to receive the straw therethrough.

15. The infuser of claim 14, wherein the clip is located within the channel of the hollow body and configured such that the straw may be removably secured within the channel.

16. The infuser of claim 15, wherein the clip is positioned near the opposite end of the channel as the wall.

17. An infuser comprising:
a cage comprised of a hollow body and a chamber, the cage being configured to hold material to be infused, the hollow body being comprised of a rim, a plurality of apertures extending through the hollow body, and the chamber being defined by the hollow body with an entrance to the chamber being defined by the rim; and
a lid comprised of a top, a bottom rim, an outer lateral surface having a length between the bottom rim and the top, and a chamber being defined by the top and outer lateral surface of the lid with an opening to the chamber being defined by the bottom rim,
wherein the rim of the cage may be removably secured within the bottom of the lid and wherein the chamber of the lid may be configured to capture air when the infuser is placed within a liquid such that the lid may float on top of the liquid while the cage may be suspended within the liquid.

18. The infuser of claim 17, wherein the lid is further comprised of a handle.

19. The infuser of claim 17, wherein the lid if further comprised of a channel running around a circumference of the outer lateral surface.

20. The infuser of claim 17, wherein the lid is further comprised of a protruded ring running completely around the interior of the outer lateral surface within the chamber.
